(19) United States
(12) Patent Application Publication
(10) Pub. No.: US 2017/0189793 A1
(43) Pub. Date: Jul. 6, 2017

(54) LOTTERY TOOL

(71) Applicant: Vincent Audino, San Jose, CA (US)

(72) Inventor: Vincent Audino, San Jose, CA (US)

(21) Appl. No.: 15/381,421

(22) Filed: Dec. 16, 2016

Related U.S. Application Data
(60) Provisional application No. 62/274,607, filed on Jan. 4, 2016.

(51) Int. Cl. A63F 3/06; B26D 3/28

(52) U.S. Cl. CPC A63F 3/061; B26D 3/281; A63F 3/068

(57) ABSTRACT

A lottery tool that is a rectangular chip with a plurality of holes which may overlay a grid of numbers on a lottery gaming slip, allowing a user to select numbers for the lottery game. The lottery tool has a randomly generated pattern of 5-10 holes and is used by randomly placing the tool over the gaming slip, by direct placement, by dropping the tool onto the betting slip, or by spinning the tool on a hub. The user then fills in the lottery slip and repeats the process until a requisite amount of numbers are selected. Opposed edges of the tool are serrated to form teeth for use in removing coatings from hidden number lottery tickets.

### CROSS-REFERENCE TO RELATED APPLICATION

This application claims the benefit from U.S. provisional application Ser. No. 62/274,607 filed Jan. 4, 2016.

### TECHNICAL FIELD

The present invention relates to a tool to aid a user in selecting randomly selected numbers for a lottery type game.

### BACKGROUND OF INVENTION

Lotteries are games of chance that have been adopted by a number of states to raise funds for specified funding priorities. Generally about half of the funds spent go to prizes, while the remaining amount is split between retailers, promotion, and the specified funding priority. The lottery administration is constantly looking for ways to promote and improve the lottery product.

Lottery games are commonly played using electronic systems. A player is given a slip of paper on which several grids of numbers are displayed. Each grid is used for one play of the lottery game. If a slip has five sets of grids, the user has the option of playing up to five tries using one slip. In one example, the PowerBall lottery game in California has an upper grid with 59 numbers in equally spaced rows of 9 and 7 equally spaced columns to give a choice of 1-59. A user selects 5 of these numbers. In addition, a lower grid has rows of 9 numbers and four columns to allow selection of a bonus number from 1-35. The user selects and marks numbers, which are then read by an electronic reader to produce a slip of paper indicating the selected pick. In a number of lottery games, an additional bonus number is selected from a second grid. Once the numbers are selected, a player pays a retailer for the games picked, the slip is electronically read, and a slip of paper generated showing the numbers picked.

In the prior art, U.S. published application 2012/0056372 to DeCastro shows a tool with a spinner having windows in the spinner for simultaneously picking numbers on a sheet below the spinner. U.S. Pat. No. 4,373,281 to Sebastian shows a spinner wheel having windows for revealing more than one letter on a wheel below the spinner wheel. A similar but more complicated spinner system is shown in U.S. Pat. No. 5,232,222 to Deutch where a number of wheels have data to be selected by an upper wheel having a window for viewing numbers on an underlying wheel. U.S. Pat. No. 5,370,393 to Taylor is similar.

Other patents for number selection include U.S. Pat. No. 2,546,441 featuring a rotating disk with a window for revealing numbers. U.S. Pat. No. 3,804,419 shows a rotating wheel with windows revealing a number of letters on an underlying disk. U.S. Pat. No. 2,246,633 and U.S. Pat. No. 5,118,110 are large spinners for multiple number selection. FIG. 3 of the '110 patent seems relevant. U.S. Pat. No. 4,875,411 to Turner shows a mechanical lottery marker with a random bet. U.S. Pat. No. 4,907,823 shows a scratching tool for a lottery ticket.

The prior art also includes numbers automatically selected by a computer. However a number of players prefer to pick their own numbers. It is an object to provide a novelty device and related method to aid in the selection of lottery numbers. It is a further object to have this same device aid in use of “scratcher” type lottery tickets.

### SUMMARY OF INVENTION

The present invention includes a lottery tool or chip with a pattern of 5-10 holes therein and a method for selecting numbers for a lottery game, the type of game where 5-7 numbers are selected and filled into a lottery slip. This slip shows a grid of spaced rows and columns of numbers. A lottery tool of the invention is a rectangular chip that is randomly placed onto the lottery slip. It is placed to overlay the lottery slip on the grid of regularly spaced rows and columns of numbers. A plurality of numbers on the lottery slip are visible through 5 to 10 holes of a hole pattern on said lottery tool or chip, said holes having equal spacing to said rows and columns of numbers. The user then marks on the lottery slip a plurality of numbers visible through the holes on the lottery tool.

The step of randomly placing the lottery tool may be effected in a variety of ways. A user may align a selected tool edge with an edge of the rows and columns of numbers. The tool has four edges and the grid has four edges, resulting in a number of different combinations for alignment of the holes on any particular lottery tool. The user could also randomly place (e.g. drop) the lottery tool onto a lottery slip placed on a surface, such that holes in said tool overlay a plurality of numbers on said lottery slip.

Additionally, the step of randomly placing the lottery tool could use a stationary hub device. This hub device could be centered on the grid of regularly spaced rows and columns of numbers or could be placed on an edge of the grid of regularly spaced rows and columns of numbers. In either case, the lottery tool would be rotated on the hub, in a spinning motion for number selection when spinning stops and numbers are viewed through holes in the tool.

### BRIEF DESCRIPTION OF DRAWINGS

FIG. 1 is a partial perspective top view of a lottery tool mounted on a surface mounted hub.

FIG. 2 is a top view of a lottery tool.

FIG. 3 is a top view of a lottery ticket with a lottery tool overlaying a grid of lottery numbers.

FIG. 4 is a top view of a lottery ticket with a lottery tool mounted on a surface mounted hub.

FIG. 5 is a top perspective view of a user holding a lottery tool and using it to remove a coating from a lottery ticket.

### DETAILED DESCRIPTION

Lottery games would increase in popularity if there was a novel and diverting new method of selecting lottery numbers. A user would have a physical interaction with the lottery slip, without having to think about the numbers to choose. A user would simply randomly place the lottery tool such that it overlays the grid of numbers on a lottery slip. The user would then select two or more numbers shown in the holes in the lottery tool. This process could be repeated until all the numbers needed for a particular lottery game had been selected. The process of random of the placement of the lottery tool could be done in various ways:

The user could align one edge of the lottery tool with an edge of the grid of numbers. This allows a user a number of different ways of orienting the hole pattern over the lottery slip.

Alternatively, the user could simply drop the lottery tool over the grid of numbers, allowing the holes in the lottery tool to randomly place over numbers on the grid.

Another alternative is to use a spinner tool, which includes a base and a hub or post. The hub is placed in one of the holes on the lottery tool. The lottery tool is then spun on the hub. When the tool stops spinning, the holes will overlay numbers on the grid of numbers on a lottery slip. A plurality of numbers could be selected by marking the numbers using a pen or pencil through the holes to mark the number on the grid.

Any of the above steps could be repeated until all the required numbers for a lottery game are selected. In addition, a plurality of similar tools, but with different randomly generated hole patterns, could be manufactured and sold to avoid game bias by a particular hole pattern. The tools can be stamped and punched in thin plastic squares.

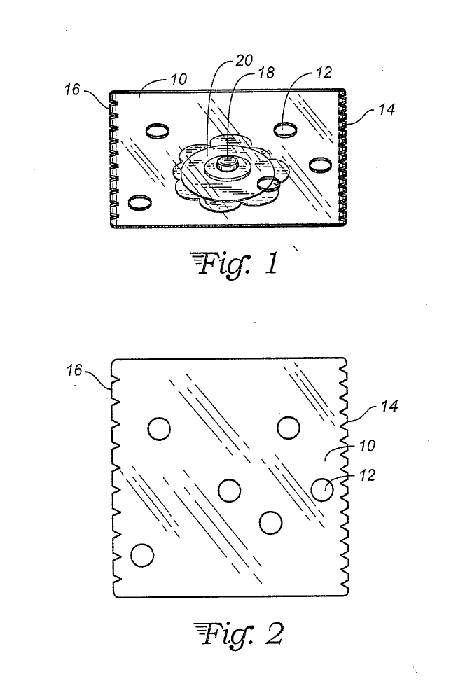

With reference to FIGS. 1 and 2, lottery tool 10 is a rectangular chip with opposed side teeth shown in edges 16 and 14 and a plurality of holes 12, preferably 5-10 holes.

The holes 12 are in the flat, planar body of the tool 10 which is a rectangular plastic chip roughly 2 inches on a side. These holes are designed to have the spacing at least equal to a distance for placement of numbers in the grid pattern of numbers in a lottery slip used for number selection in a lottery game. Since lottery numbers are not usually arranged in a perfect grid pattern, the spacing of holes in the tool may correspond to increments of the average distance for placement of numbers in both rows or columns. As seen in

FIG. 1, the lottery tool may be used with a hub 18 mounted on a hub base 20. This hub is placed through a hole 12 on lottery tool 10. This allows the lottery tool to spin, and the holes in the lottery tool to overlay different numbers on the grid of numbers on a lottery ticket.

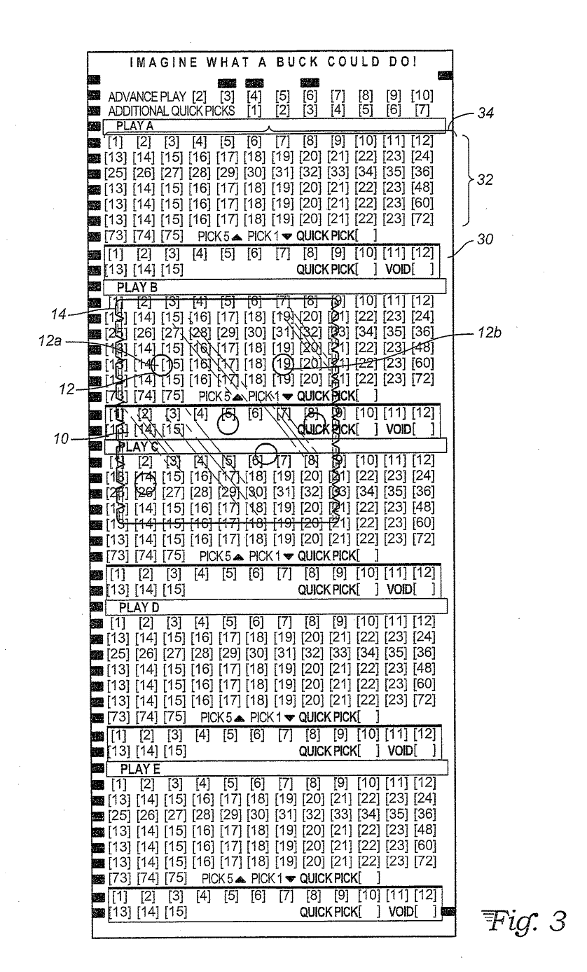

With reference to FIG. 3, a lottery ticket 30 is shown. The lottery ticket allows multiple game plays, each requiring selection of a set of numbers from a grid of numbers set out in rows 34 and columns 32. The spacing of numbers provides a regular grid. The lottery tool 10 is positioned randomly on the lottery slip, with edges of the lottery tool 10 placed within the edges of the grid of numbers on the lottery slip. Holes 12a, 12b on lottery tool 10 show numbers that may be selected by using a pen or pencil to mark the numbers on the lottery slip through the holes 12a, 12b in the lottery tool.

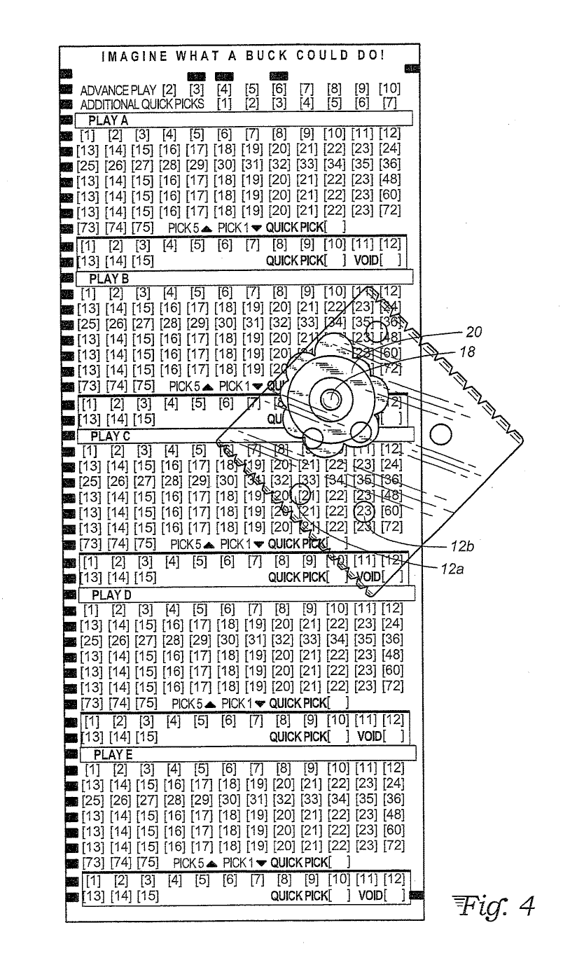

A way to create random numbers is shown with reference to FIG. 4. A hub 18 on a base 20 is placed on the lottery slip. One of the holes in lottery tool 10 is then placed over the hub and the tool is rotated by a user, for example, by flicking an edge of the lottery tool and allowing the tool to spin on the hub. When the lottery tool stops rotating, a user can select holes on the lottery tool that align with numbers on a grid of numbers on the lottery slip.

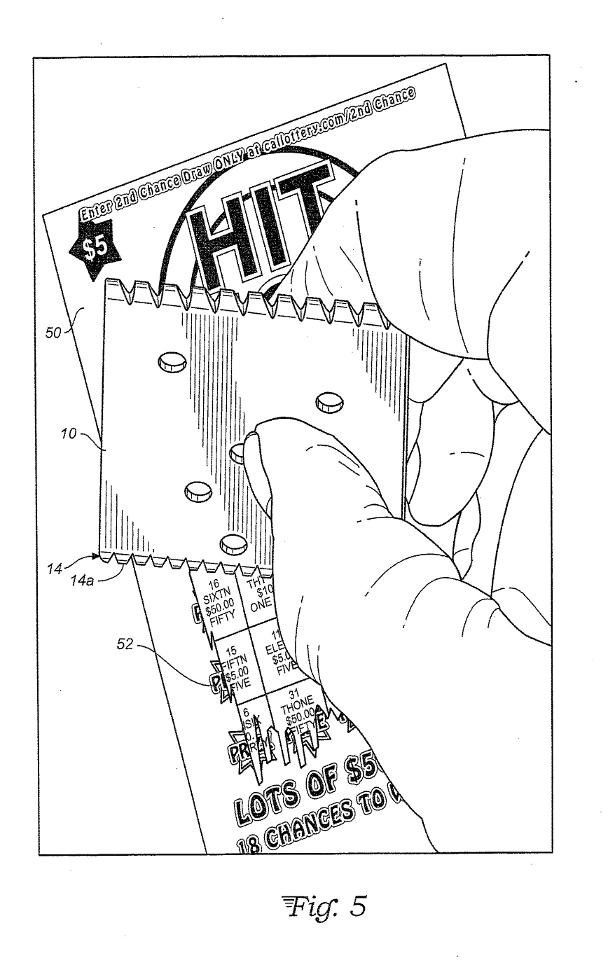

Opposed edges of the tool could be serrated as seen in FIG. 5, forming teeth, so that the chip could be used for scratching hidden numbers covered by removable coatings. These teeth are shown with larger teeth on edge 16 and smaller teeth on edge 14 in FIG. 5. The coating 52 on a “scratcher” type lottery ticket is shown being removed by the scratching teeth 14a of the lottery tool 10. The “scratcher” type lottery ticket 50 shown is a $5 ticket with rows and columns of prize numbers. A user removes an overlaying coating to determine if the under laying amounts align to signal a prize award. The present lottery tool allows the coating to be removed in a simple, effective and efficient manner, without damaging or erasing the card by damaging the ink markings that underlay the coating. Unlike a coin (which is commonly used to remove the overlaying coating) the present lottery tool will not cause the lottery ticket to warp or bend.

What is claimed is:

1. A method of selecting numbers for a lottery game in which a plurality of numbers is to be selected from a lottery slip showing a grid of spaced rows and columns of numbers, the method comprising:
randomly placing a chip with a pattern of 5 to 10 holes therein to overlay said lottery slip showing the grid of spaced rows and columns of numbers such that a plurality of numbers on said lottery slip are visible through holes of a hole pattern on said lottery tool, said holes having spacing at least equal to a distance for placement of numbers in said rows and columns of numbers; and
marking on said lottery slip a plurality of numbers visible through said holes.

2. The method of claim 1, wherein randomly placing said chip includes aligning a user selected edge with an edge of said rows and columns of numbers.

3. The method of claim 1, wherein randomly placing said lottery tool includes dropping said chip onto a lottery slip such that holes in said chip overlay a plurality of numbers on said lottery slip.

4. The method of claim 1, wherein randomly placing said chip includes placing a stationary hub device onto said lottery slip over said spaced rows and columns of numbers, and placing a hole in said chip onto said hub.

5. The method of claim 4, wherein said hub is centered on said spaced rows and columns of numbers.

6. The method of claim 4, wherein said hub is on an edge of said grid of spaced rows and columns of numbers.

7. A lottery tool for use with a lottery slip having rows and columns of a spaced apart sequence of numbers and with a lottery slip having hidden numbers comprising:
a hand held plastic rectangular chip having 5 to 10 holes in a random pattern wherein the spacing of holes is at least equal to a distance associated with the spaced apart sequence of numbers.

8. The apparatus of claim 7 wherein the spacing of holes corresponds to increments of the average distance of number spacing in rows and columns of the lottery slip.

9. The apparatus of claim 7 wherein the plastic rectangular chip has opposed edges that are serrated forming teeth.

10. The apparatus of claim 7 further comprising a base and hub, with the hub fitting into one of said holes.
